(19) United States
(12) Patent Application Publication
(10) Pub. No.: US 2026/0073874 A1
(43) Pub. Date: Mar. 12, 2026

(54) METHOD OF DETERMINING AN APERTURE RATIO, APERTURE RATIO DETERMINATION DEVICE AND ELECTRONIC DEVICE DESIGNED BY THE METHOD OF DETERMINING THE APERTURE RATIO

(71) Applicant: Samsung Display Co., Ltd., Yongin-si (KR)

(72) Inventors: HEE-KWANG SONG, Yongin-si (KR); SANGKYUNG LEE, Yongin-si (KR); SANG JOON RYU, Yongin-si (KR)

(21) Appl. No.: 19/292,534

(22) Filed: Aug. 6, 2025

(30) Foreign Application Priority Data
Sep. 10, 2024 (KR) 10-2024-0123438

(51) Int. Cl. G09G 3/3258; G09G 3/3266; G09G 3/3275

(52) U.S. Cl. CPC G09G 3/3258; G09G 3/3266; G09G 3/3275; G09G 2300/0465; G09G 2320/0233; G09G 2360/16

(57) ABSTRACT

A method of determining an aperture ratio includes: calculating a current density ratio of a pixel of a display device; calculating a total stress of the pixel based on lifetime data of the pixel and the current density ratio of the pixel; calculating a threshold voltage variance of a driving transistor included in the pixel; and determining the aperture ratio of the pixel based on a relationship between the total stress of the pixel and the threshold voltage variance of the driving transistor.

### CROSS-REFERENCE TO RELATED APPLICATION

The present application claims priority to and the benefit of Korean Patent Application No. 10-2024-0123438, filed on Sep. 10, 2024, in the Korean Intellectual Property Office, the entire disclosure of which is incorporated by reference herein.

### BACKGROUND

### 1. Field

Embodiments of the present disclosure relate to a display device. More particularly, embodiments of the present disclosure relate to a method of determining an aperture ratio, an aperture ratio determination device, and an electronic device including a pixel having the aperture ratio thereof determined by the method of determining the aperture ratio.

### 2. Description of the Related Art

Generally, a display device included in an electronic device may include a display panel and a display panel driver. The display panel may include a plurality of scan lines, a plurality of data lines, and a plurality of pixels. The display panel driver may include a scan driver for providing scan signals to the scan lines, a data driver for providing data voltages to the data lines, and a driving controller for controlling the scan driver and the data driver.

The above information disclosed in this Background section is for enhancement of understanding of the background of the present disclosure, and therefore, it may contain information that does not constitute prior art.

### SUMMARY

Pixels may be produced using various suitable materials. An amount of stress applied to each of the pixels may vary depending on the material. As the amount of the stress applied to the pixels increases, a threshold voltage of a driving transistor may be shifted beyond a maximum value of a compensation voltage for a threshold voltage variance of the driving transistor. Accordingly, the pixels may not emit light at a desired target luminance.

Some embodiments of the present disclosure may be directed to a method of determining an aperture ratio to improve a luminance expression capability of a pixel.

Some embodiments of the present disclosure may be directed to an aperture ratio determination device for performing the method of determining the aperture ratio.

Some embodiments of the present disclosure may be directed to an electronic device including a pixel having the aperture ratio thereof determined by the method of determining the aperture ratio.

According to one or more embodiments of the present disclosure, a method of determining an aperture ratio includes: calculating a current density ratio of a pixel of a display device; calculating a total stress of the pixel based on lifetime data of the pixel and the current density ratio of the pixel; calculating a threshold voltage variance of a driving transistor included in the pixel; and determining the aperture ratio of the pixel based on a relationship between the total stress of the pixel and the threshold voltage variance of the driving transistor.

In an embodiment, the lifetime data of the pixel may correspond to a lifetime used for a luminance maintenance ratio of the pixel to decrease from about 100% to about 50%.

In an embodiment, the calculating of the current density ratio of the pixel may include: calculating a current density of the pixel based on an initial aperture ratio of the pixel; and calculating the current density ratio of the pixel by calculating a ratio of the current density of the pixel to a reference current density of a reference pixel.

In an embodiment, the total stress of the pixel may be calculated based on (CDR\hat{ }k)*PLT, where CDR may be the current density ratio of the pixel, PLT may be a lifetime of the pixel corresponding to the lifetime data of the pixel, and k may be a constant value.

In an embodiment, the relationship between the total stress of the pixel and the threshold voltage variance of the driving transistor may be a linear relationship.

In an embodiment, the determining of the aperture ratio of the pixel may include determining a first reference total stress corresponding to a maximum threshold voltage compensation value corresponding to a maximum value of a compensation voltage for the threshold voltage variance of the driving transistor.

In an embodiment, the determining of the aperture ratio of the pixel may further include determining the aperture ratio corresponding to the first reference total stress when the total stress is greater than the first reference total stress.

In an embodiment, the determining of the aperture ratio of the pixel may further include determining the aperture ratio corresponding a second reference total stress that may be less than the first reference total stress when the total stress is greater than the first reference total stress.

According to one or more embodiments of the present disclosure, an aperture ratio determination device includes: a current density ratio calculator configured to calculate a current density ratio of a pixel; a total stress calculator configured to calculate a total stress of the pixel based on lifetime data of the pixel and the current density ratio of the pixel; a threshold voltage variance calculator configured to calculate a threshold voltage variance of a driving transistor included in the pixel; and an aperture ratio determiner configured to determine an aperture ratio of the pixel based on the threshold voltage variance of the driving transistor and the total stress of the pixel.

In an embodiment, the lifetime data of the pixel may correspond to a lifetime used for a luminance maintenance ratio of the pixel to decrease from about 100% to about 50%.

In an embodiment, the current density ratio calculator may be configured to calculate a current density of the pixel based on an initial aperture ratio of the pixel, and calculate the current density ratio of the pixel by calculating a ratio of the current density of the pixel to a reference current density of a reference pixel.

In an embodiment, the aperture ratio determination device may further include a lifetime calculator configured to calculate a lifetime used for a luminance maintenance ratio of the pixel to decrease from about 100% to about 50%, and provide the lifetime data corresponding to the lifetime of the pixel to the total stress calculator.

In an embodiment, the total stress calculator may be configured to calculate the total stress of the pixel based on (CDR\hat{ }k)*PLT, where CDR may be the current density ratio of the pixel, PLT may be a lifetime of the pixel corresponding to the lifetime data of the pixel, and k may be a constant value.

In an embodiment, the aperture ratio determiner may be configured to determine a relationship between the total stress of the pixel and the threshold voltage variance of the driving transistor.

In an embodiment, the relationship between the total stress of the pixel and the threshold voltage variance of the driving transistor may be a linear relationship.

In an embodiment the aperture ratio determiner may be configured to determine a first reference total stress corresponding to a maximum threshold voltage compensation value corresponding to a maximum value of a compensation voltage for the threshold voltage variance of the driving transistor.

In an embodiment the aperture ratio determiner may be configured to determine the aperture ratio corresponding to the first reference total stress when the total stress is greater than the first reference total stress.

In an embodiment, the aperture ratio determiner may be configured to determine a second reference total stress that may be less than the first reference total stress when the total stress is greater than the first reference total stress, and determine the aperture ratio corresponding to the second reference total stress.

According to one or more embodiments of the present disclosure, an electronic device includes: a processor configured to output an input control signal and input image data; a display panel including a pixel; a scan driver configured to output a scan signal to the pixel; a data driver configured to output a data voltage to the pixel; a sensing circuit connected to the pixel through a sensing line; a driving controller configured to control the scan driver, the data driver, and the sensing circuit, based on the input control signal and the input image data; and a current density ratio of the pixel is calculated, a total stress of the pixel is calculated based on lifetime data of the pixel and the current density ratio of the pixel, a threshold voltage variance of a driving transistor included in the pixel is calculated, and an aperture ratio of the pixel is determined based on a relationship between the threshold voltage variance of the driving transistor and the total stress of the pixel.

In an embodiment, the current density ratio may be a ratio of a current density of the pixel to a reference current density of a reference pixel, the lifetime data may correspond to a lifetime of the pixel, and the total stress may be calculated based on (CDR\hat{ }k)*PLT, where CDR may be the current density ratio of the pixel, PLT may be the lifetime of the pixel corresponding to the lifetime data of the pixel, and k may be a constant value.

According to some embodiments of the present disclosure, an aperture ratio determination device may determine the aperture ratio of a pixel. For example, the aperture ratio determination device may redetermine the aperture ratio of the pixel by using a method of determining the aperture ratio. The aperture ratio determined by the aperture ratio determination device may be higher than an initial aperture ratio. When the aperture ratio increases, a current efficiency of the pixel may increase, and a current density of the pixel may decrease. When the current efficiency of the pixel increases, total stress applied to the pixel may decrease. When the total stress decreases, a threshold voltage variance of a driving transistor included in the pixel may decrease. When the threshold voltage variance of the driving transistor decreases, the threshold voltage variance of the driving transistor may be smaller than a maximum threshold voltage compensation value, which is a maximum value of a compensation voltage for the threshold voltage variance of the driving transistor. The threshold voltage variance of the driving transistor may be within a compensation range for the threshold voltage of the driving transistor, so that the pixel may exactly emit light at a target luminance without a current reduction. In other words, a luminance expression capability of the pixel may be improved. Accordingly, a display quality of the display device may be improved.

According to some embodiments of the present disclosure, when the current efficiency of the pixel increases, a lifetime of the pixel may be increased. As such, a stability and a reliability of the display device including the pixel having an increased lifetime may be improved.

According to some embodiments of the present disclosure, when the current density of the pixel decreases, a driving current of the pixel may be decreased. Accordingly, a power consumption of the display device including the pixel having a decreased current density may be decreased.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 is a block diagram illustrating a display device according to some embodiments of the present disclosure;

FIG. 2 is a circuit diagram illustrating a pixel included in a display panel of FIG. 1 according to an embodiment of the present disclosure;

FIG. 3 is a block diagram illustrating an aperture ratio determination device according to an embodiment of the present disclosure;

FIG. 4 is a table illustrating a stress according to a size of the display panel of FIG. 1 and a kind of the pixel included in the display panel;

FIG. 5A is a table illustrating measurement values according to the kind of the pixel of the display panel of FIG. 1 according to an embodiment of the present disclosure;

FIG. 5B is a table illustrating measurement values according to the kind of the pixel of the display panel of FIG. 1 according to an embodiment of the present disclosure;

FIG. 5C is a table illustrating measurement values according to the kind of the pixel of the display panel of FIG. 1 according to an embodiment of the present disclosure;

FIG. 6 is a graph illustrating a relationship between a total stress of the pixel and a threshold voltage variance;

FIG. 7 is a graph illustrating a total stress range according to a driving voltage margin of the pixel;

FIG. 8 is a block diagram illustrating an aperture ratio determination device according to an embodiment of the present disclosure;

FIG. 9 is a flow chart illustrating a method of determining the aperture ratio;

FIG. 10 is a block diagram illustrating an electronic device according to some embodiments of present disclosure; and

FIG. 11 is a diagram illustrating the electronic device of FIG. 10 implemented as a smart phone according to an embodiment of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

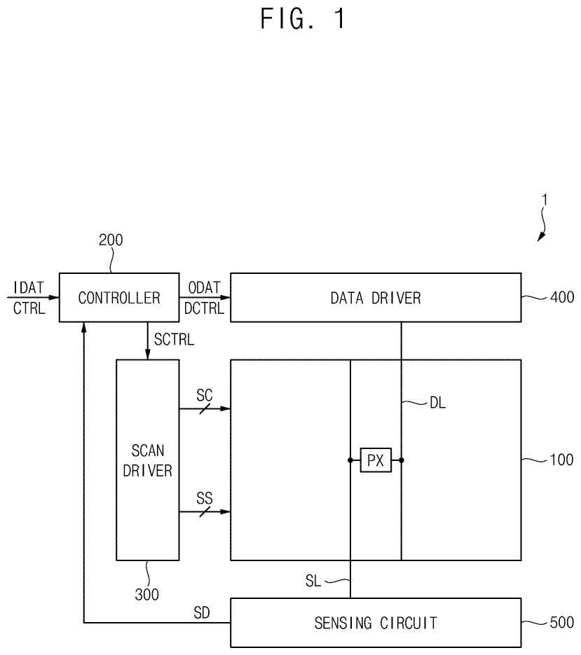

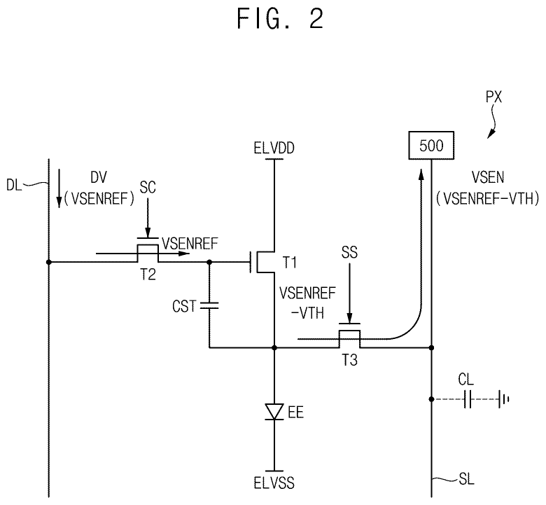

FIG. 1 is a block diagram illustrating a display device 1 according to some embodiments of the present disclosure. FIG. 2 is a circuit diagram illustrating a pixel PX included in a display panel 100 of FIG. 1 according to an embodiment of the present disclosure.

Referring to FIGS. 1 and 2, the display device 1 may include the display panel 100 including a plurality of pixels PX, a scan driver 300 for providing a scan signal SC and a sensing signal SS to each of the pixels PX, a data driver 400 for providing a data voltage DV to each of the pixels PX, a sensing circuit 500 connected to the pixels PX through sensing lines SL, and a driving controller 200 for controlling the scan driver 300, the data driver 400, and the sensing circuit 500.

The display panel 100 may include data lines DL, scan lines, sensing signal lines, the sensing lines SL, and the pixels PX. For example, a light emitting element EE of a pixel PX may be an organic light emitting diode (OLED). For example, the light emitting element EE may be a nano light emitting diode (NED), a quantum dot-organic light emitting diode (QD-OLED), a micro light emitting diode, an inorganic light emitting diode, or any other suitable light emitting element.

The scan driver 300 may generate the scan signals SC and the sensing signals SS based on a scan control signal SCTRL received from the driving controller 200, and may sequentially provide the scan signals SC and the sensing signals SS to the pixels PX on a row-by-row basis. For example, the scan control signal SCTRL may include a scan start signal and a scan clock signal, but the scan control signal SCTRL is not limited thereto. For example, the scan driver 300 may be integrated in or formed on a peripheral region of the display panel 100. For example, the scan driver 300 may be implemented as one or more integrated circuits.

The data driver 400 may generate the data voltages DV based on output image data ODAT and a data control signal DCTRL received from the driving controller 200, and may provide the data voltages DV to the pixels PX. In an embodiment, the data driver 400 may provide a sensing reference voltage VSENREF to the pixels PX of a selected pixel row in (e.g., during) a sensing period. For example, the data control signal DCTRL may include a horizontal start signal, an output data enable signal, a load signal, and/or the like, but the data control signal DCTRL is not limited thereto. For example, the data driver 400 may be implemented as one or more integrated circuits. For example, the data driver 400 and the driving controller 200 may be implemented together as a single integrated circuit, and the single integrated circuit may be referred to as a timing controller embedded data driver (TED).

The sensing circuit 500 may sense characteristics of the pixels PX of the selected pixel row. For example, the sensing circuit 500 may sense a threshold voltage variance of a driving transistor included in the pixels PX.

The sensing circuit 500 may provide sensing data SD generated by sensing the pixels PX to the driving controller 200. In an embodiment, the driving controller 200 may correct input image data IDAT based on the sensing data SD.

For example, the sensing circuit 500 may be implemented as a separate integrated circuit from that of the data driver 400. For example, the data driver 400 and the sensing circuit may be implemented together as a single integrated circuit.

The driving controller 200 may receive the input image data IDAT and a control signal CTRL from an external host processor (e.g. a graphics processing unit (GPU), an application processor (AP), or a graphics card). For example, the control signal CTRL may include a vertical synchronizing signal, a horizontal synchronizing signal, an input data enable signal, a master clock signal, and/or the like, but the control signal CTRL is not limited thereto. The driving controller 200 may generate the output image data ODAT by correcting the input image data IDATA based on the sensing data SD. In addition, the driving controller 200 may generate the data control signal DCTRL and the scan control signal SCTRL based on the control signal CTRL. The driving controller 200 may control the scan driver 300 by providing the scan control signal SCTRL to the scan driver 300, and may control the data driver 400 by providing the output image data ODAT and the data control signal DCTRL to the data driver 400.

Each of the pixels PX may include a first transistor T1, a second transistor T2, a third transistor T3, a storage capacitor CST, and a light emitting element EE, but the present disclosure is not limited thereto, and each of the pixels PX may be variously modified as needed or desired.

The first transistor T1 may include a control electrode connected to a second electrode of the second transistor T2, a first electrode for receiving a first power supply voltage ELVDD, and a second electrode connected to an anode electrode of the light emitting element EE. The first transistor T1 may be referred to as the driving transistor.

The second transistor T2 may include a control electrode for receiving the scan signal SC, a first electrode for receiving the data voltage DV, and the second electrode connected to the control electrode of the first transistor T1.

The third transistor T3 may include a control electrode for receiving the sensing signal SS, a first electrode connected to the anode electrode of the light emitting element EE, and a second electrode connected to the sensing circuit 500 through the sensing line SL. The sensing line SL may include a parasitic capacitor CL.

The storage capacitor CST may include a first electrode connected to the control electrode of the first transistor T1, and a second electrode connected to the anode electrode of the light emitting element EE.

The light emitting element EE may include the anode electrode connected to the second electrode of the first transistor T1, and a cathode electrode for receiving a second power supply voltage ELVSS.

In the sensing period, the scan driver 300 may provide the scan signal SC and the sensing signal SS to each of the pixels PX of the selected pixel row, and the data driver 400 may provide the sensing reference voltage VSENREF to each of the pixels PX of the selected pixel row. The second transistor T2 may transmit the sensing reference voltage VSENREF to the control electrode of the first transistor T1 in response to the scan signal SC. When the sensing reference voltage VSENREF is applied to the control electrode of the first transistor T1, a voltage of the second electrode (e.g., a source electrode) of the first transistor T1 may be saturated to a voltage (VSENREF-VTH), which is the sensing reference voltage VSENREF minus a threshold voltage VTH of the first transistor T1. The third transistor T3 may transmit the voltage (VSENREF-VTH) of the second electrode of the first transistor T1 to the sensing line SL in response to the sensing signal SS, and the sensing circuit 500 may sense the voltage (VSENREF-VTH), which is the sensing reference voltage VSENREF minus the threshold voltage VTH of the first transistor T1, as a sensing voltage VSEN of the sensing line SL.

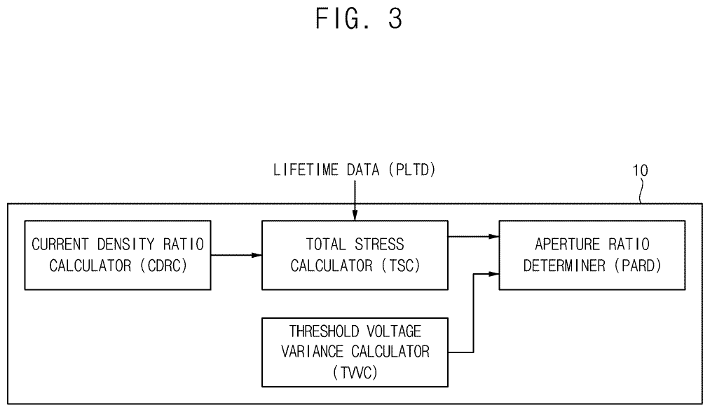

FIG. 3 is a block diagram illustrating an aperture ratio determination device 10 according to an embodiment of the present disclosure.

Referring to FIG. 3, the aperture ratio determination device 10 may include a current density ratio calculator CDRC, a total stress calculator TSC, a threshold voltage variance calculator TVVC, and an aperture ratio determiner PARD.

The aperture ratio determination device 10 may determine an aperture ratio of the pixel PX based on a total stress of the pixel PX and the threshold voltage variance of the first transistor T1 included in the pixel PX.

An aperture ratio may refer to a ratio of an aperture area from which light is emitted to an entire area of the pixel PX. When the aperture ratio is high, the pixel PX of the display panel 100 may emit more light. When the aperture ratio increases, a current efficiency of the pixel PX may increase. When the current efficiency of the pixel PX increases, a lifetime of the pixel PX may increase. When the current efficiency of the pixel PX increases, a current density of the pixel PX may decrease. In other words, when the aperture ratio increases, the current density of the pixel PX may decrease.

The current density ratio calculator CDRC may determine the current density based on an initial aperture of the pixel PX. In addition, the current density ratio calculator CDRC may determine a current density ratio based on the current density of the pixel PX. The current density ratio may refer to a ratio of the current density of the pixel PX for determining the aperture ratio to a reference current density of a reference pixel included in the display panel 100. In other words, the current density ratio calculator CDRC may calculate the ratio of the current density of the pixel PX to the reference current density of the reference pixel. The current density ratio calculator CDRC may transmit data for the current density ratio of the pixel PX to the total stress calculator TSC. For example, the reference pixel included in the display panel 100 may be a red pixel, and the current density of the red pixel may be about 92.89 mA/cm\hat{ }2. The pixel PX for determining the aperture ratio (e.g., in which the aperture ratio is determined) may be a blue pixel, and the current density of the blue pixel may be about 135.55 mA/cm\hat{ }2. The current density ratio of the blue pixel may be a value corresponding to (e.g., which is) the current density of the blue pixel divided by the current density of the red pixel. In other words, the current density ratio of the blue pixel may be about 1.45925288, which is about 135.55 mA/cm\hat{ }2 divided by about 92.89 mA/cm\hat{ }2.

The total stress calculator TSC may receive lifetime data PLTD representing the lifetime of the pixel PX from an external device. The total stress calculator TSC may calculate the total stress of the pixel PX based on the data for the current density ratio of the pixel PX and the lifetime data PLTD for the lifetime of the pixel PX. The total stress may refer to a total amount of stress applied to the pixel PX. The total stress calculator TSC may transmit data for the total stress to the aperture ratio determiner PARD.

The total stress calculator TSC may calculate the total stress using an equation ((CDR\hat{ }k)*PLT), where CDR is the current density ratio of the pixel PX, PLT is the lifetime of the pixel PX, and k is a constant value. For example, k may be greater than or equal to about 1.3, and less than or equal to about 1.9. For example, k may be about 1.3. For example, k may be about 1.9.

The threshold voltage variance calculator TVVC may calculate the threshold voltage variance of the first transistor T1 included in the pixel PX. The threshold voltage variance calculator TVVC may calculate a difference value between an initial threshold voltage of the first transistor T1 and a current threshold voltage of the first transistor T1, by comparing the initial threshold voltage of the first transistor T1 and the current threshold voltage of the first transistor T1. The threshold voltage variance calculator TVVC may transmit data for the threshold voltage variance of the first transistor T1 to the aperture ratio determiner PARD.

The aperture ratio determiner PARD may calculate a relationship between the total stress of the pixel PX and the threshold voltage variance of the first transistor T1 based on the total stress of the pixel PX and the threshold voltage variance of the first transistor T1. In an embodiment, the relationship between the total stress of the pixel PX and the threshold voltage variance of the first transistor T1 may be a linear relationship. The aperture ratio determiner PARD may determine a maximum threshold voltage compensation value, which is a maximum value of a compensation voltage for the threshold voltage variance of the first transistor T1, to determine the aperture ratio. The aperture ratio determiner PARD may determine the aperture ratio based on the relationship between the total stress of the pixel PX and the threshold voltage variance of the first transistor T1 and the maximum threshold voltage compensation value. In an embodiment, the maximum threshold voltage compensation value may be determined within a power consumption range of the display device 1.

A newly determined aperture ratio may be higher than the initial aperture ratio. When the aperture ratio increases, the current efficiency of the pixel PX may increase, and the current density of the pixel PX may decrease. When the current efficiency of the pixel PX increases, the total stress applied to the pixel PX may decrease. When the total stress decreases, the threshold voltage variance of the first transistor T1 included in the pixel PX may decrease. When the threshold voltage variance of the first transistor T1 decreases, the threshold voltage variance of the first transistor T1 may be less than the maximum threshold voltage compensation value. The threshold voltage variance of the first transistor T1 may be within a compensation range for the threshold voltage of the first transistor T1, so that the pixel PX may emit light at a desired target luminance without a current reduction. In other words, a luminance expression capability of the pixel PX may be improved. Accordingly, a display quality of the display device 1 may be improved.

In addition, when the current efficiency of the pixel PX increases, the lifetime of the pixel PX may increase. A stability and a reliability of the display device 1 including the pixel PX having an increased lifetime may be improved.

In addition, when the current density of the pixel PX decreases, a driving current of the pixel PX may decrease. Accordingly, a power consumption of the display device 1 including the pixel PX having the decreased current density may decrease.

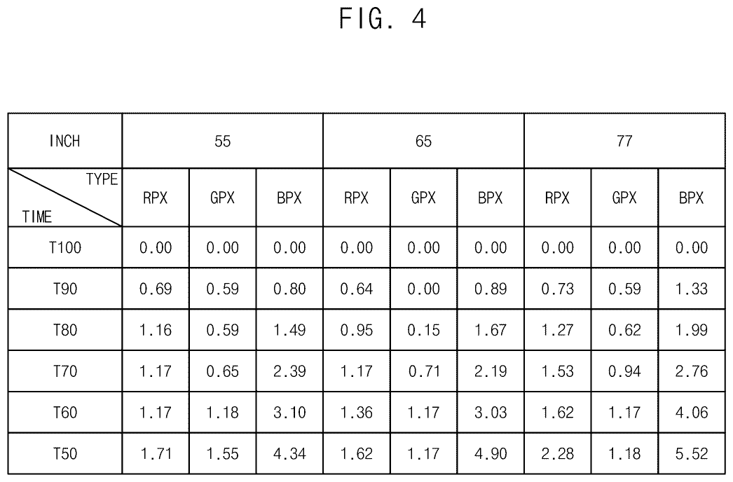

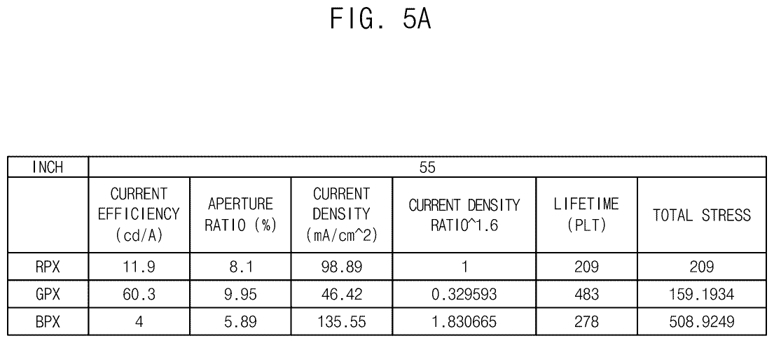

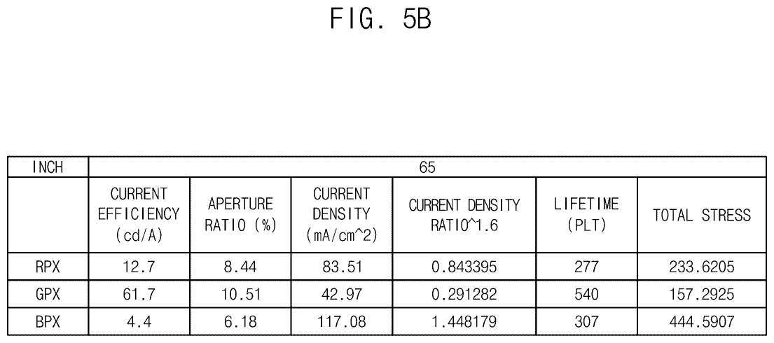

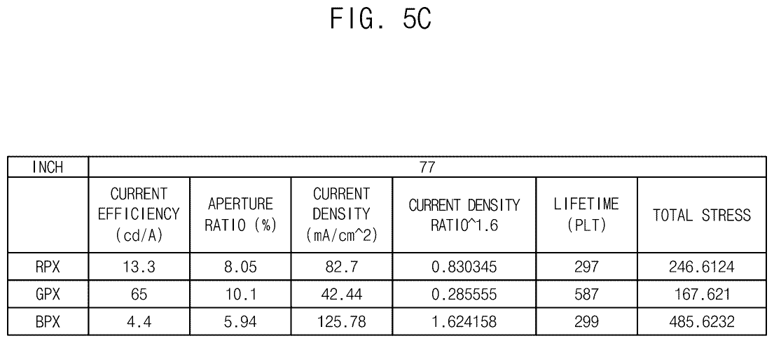

FIG. 4 is a table illustrating a stress according to a size of the display panel 100 of FIG. 1 and a kind of the pixel PX included in the display panel 100. FIG. 5A is a table illustrating measurement values according to the kind of the pixel PX of the display panel 100 of FIG. 1 according to an embodiment of the present disclosure. FIG. 5B is a table illustrating measurement values according to the kind of the pixel PX of the display panel 100 of FIG. 1 according to an embodiment of the present disclosure. FIG. 5C is a table illustrating measurement values according to the kind of the pixel PX of the display panel 100 of FIG. 1 according to an embodiment of the present disclosure.

Referring to FIG. 4, the size of the display panel 100 and the kind of the pixel PX included in the display panel 100 may be designed in various suitable ways. In addition, the stress applied to the pixel PX during a same time may be different depending on the kind of the pixel PX. For convenience of illustration, the kinds of the pixel PX may include a red pixel RPX for emitting a red light, a green pixel GPX for emitting a green light, and a blue pixel BPX for emitting a blue light.

A first time T100 may be a time taken until a luminance maintenance ratio of the pixel PX is about 100%. A second time T90 may be a time taken until the luminance maintenance ratio of the pixel PX decreases from about 100% to about 90%. In this way, a sixth time T50 may be a time taken until the luminance maintenance ratio of the pixel PX decreases from about 100% to about 50%. The sixth time T50 may be the lifetime PLT of the pixel PX.

The luminance maintenance ratio refers to a ratio of a luminance in which the pixel PX emits light when a first data voltage corresponding the first luminance is applied to the pixel PX to a first luminance. For example, when the luminance maintenance ratio is about 100%, the pixel PX may emit light at the first luminance when the first data voltage is applied to the pixel PX. For example, when the luminance maintenance ratio is about 50%, the pixel PX may emit light at about 50% of the first luminance when the first data voltage is applied to the pixel PX.

The stress applied to the red pixel RPX, the green pixel GPX, and the blue pixel BPX during the same time may be different from each other. In addition, as a time in which the first data voltage is applied increases, the stress applied to the red pixel RPX, the green pixel GPX, and the blue pixel BPX may increase, regardless of the size of the display panel 100.

In an embodiment, the size of the display panel 100 may be 55 inches. In the first time T100, the stress applied to the red pixel RPX, the green pixel GPX, and the blue pixel BPX may be 0. In the sixth time T50, the stress applied to the red pixel RPX may be 1.71, the stress applied to the green pixel GPX may be 1.55, and the stress applied to the blue pixel BPX may be 4.34. In other words, as the time in which the first data voltage is applied increases, the stress applied to the pixel PX may increase. In addition, the stress applied to the blue pixel BPX may be the greatest. The threshold voltage variance of the first transistor T1 included in the blue pixel BPX may be greater than the compensation range for the threshold voltage of the first transistor T1 included in the blue pixel BPX. Accordingly, the blue pixel BPX may not exactly emit light at the target luminance, and a flicker may be visible in the display device 1.

In an embodiment, the size of the display panel 100 may be 65 inches. In the first time T100, the stress applied to the red pixel RPX, the green pixel GPX, and the blue pixel BPX may be 0. In the sixth time T50, the stress applied to the red pixel RPX may be 1.62, the stress applied to the green pixel GPX may be 1.17, and the stress applied to the blue pixel BPX may be 4.90. In other words, as the time in which the first data voltage is applied increases, the stress applied to the pixel PX may increase. In addition, the stress applied to the blue pixel BPX may be the greatest.

The threshold voltage variance of the first transistor T1 included in the blue pixel BPX may be greater than the compensation range for the threshold voltage of the first transistor T1 included in the blue pixel BPX. Accordingly, the blue pixel BPX may not exactly emit light at the target luminance, and the flicker may be visible in the display device 1.

In an embodiment, the size of the display panel 100 may be 77 inches. In the first time T100, the stress applied to the red pixel RPX, the green pixel GPX, and the blue pixel BPX may be 0. In the sixth time T50, the stress applied to the red pixel RPX may be 2.28, the stress applied to the green pixel GPX may be 1.18, and the stress applied to the blue pixel BPX may be 5.52. In other words, as the time in which the first data voltage is applied increases, the stress applied to the pixel PX may increase. In addition, the stress applied to the blue pixel BPX may be the greatest. The threshold voltage variance of the first transistor T1 included in the blue pixel BPX may be greater than the compensation range for the threshold voltage of the first transistor T1 included in the blue pixel BPX. Accordingly, the blue pixel BPX may not exactly emit light at the target luminance, and the flicker may be visible in the display device 1.

Referring to FIGS. 5A to 5C, the total stress of the pixel PX may be different according to the kind of the pixel PX, regardless of the size of the display panel 100.

In an embodiment, the size of the display panel 100 may be about 55 inches. The current efficiency cd/A of the red pixel RPX may be about 11.9 cd/A, the current efficiency cd/A of the green pixel GPX may be about 60.3 cd/A, and the current efficiency cd/A of the blue pixel BPX may be about 4 cd/A. The aperture ratio % of the red pixel RPX may be about 8.1%, the aperture ratio % of the green pixel GPX may be about 9.95%, and the aperture ratio % of the blue pixel BPX may be about 5.89%.

The current density ratio calculator CDRC may determine the current density mA/cm\hat{ }2 of the red pixel RPX (e.g. about 98.89 mA/cm\hat{ }2) based on the aperture ratio % of the red pixel RPX (e.g. about 8.1%). In addition, the current density ratio calculator CDRC may determine the current density mA/cm\hat{ }2 of the green pixel GPX (e.g. about 46.42 mA/cm\hat{ }2) based on the aperture ratio % of the green pixel GPX (e.g. about 9.95%). In addition, the current density ratio calculator CDRC may determine the current density mA/cm\hat{ }2 of the blue pixel BPX (e.g. about 135.55 mA/cm\hat{ }2) based on the aperture ratio % of the blue pixel BPX (e.g. about 5.89%).

The current density ratio calculator CDRC may calculate the current density ratio of the red pixel RPX, the current density ratio of the green pixel GPX, and the current density ratio of the blue pixel BPX, based on the current density mA/cm\hat{ }2 of the red pixel RPX, the current density mA/cm\hat{ }2 of the green pixel GPX, and the current density mA/cm\hat{ }2 of the blue pixel BPX. For example, the reference pixel may be the red pixel RPX. The current density ratio of the blue pixel BPX may be a value that is the current density mA/cm\hat{ }2 of the blue pixel BPX divided by the current density mA/cm\hat{ }2 of the red pixel RPX. In addition, the current density ratio of the green pixel GPX may be a value that is the current density mA/cm\hat{ }2 of the green pixel GPX divided by the current density mA/cm\hat{ }2 of the red pixel RPX.

The total stress calculator TSC may receive the lifetime data PLTD of the red pixel RPX, the lifetime data PLTD of the green pixel GPX, and the lifetime data PLTD of the blue pixel BPX from the external device. The lifetime PLT of the red pixel RPX may be about 209 hrs, the lifetime PLT of the green pixel GPX may be about 483 hrs, and the lifetime PLT of the blue pixel BPX may be about 278 hrs.

The total stress calculator TSC may calculate the total stress of the pixel PX using the equation ((CDR\hat{ }K)*PLT), where CDR is the current density ratio of the pixel PX, PLT is the lifetime PLT of the pixel PX, and k is the constant value. For example, k may be greater than or equal to about 1.3, and smaller than or equal to about 1.9. For example, k may be about 1.6. For example, k may be about 1.3. For example, k may be about 1.9. For convenience of illustration, k may be about 1.6 hereinafter.

The current density rato\hat{ }1.6 of the red pixel RPX may be 1, and the lifetime PLT of the red pixel RPX may be about 209 hrs. Accordingly, the total stress of the red pixel RPX calculated by the total stress calculator TSC may be about 209. In addition, the current density rato\hat{ }1.6 of the green pixel GPX may be about 0.329593, and the lifetime PLT of the green pixel GPX may be about 483 hrs. Accordingly, the total stress of the green pixel GPX calculated by the total stress calculator TSC may be about 159.1934. In addition, the current density rato\hat{ }1.6 of the blue pixel BPX may be about 1.830665, and the lifetime PLT of the blue pixel BPX may be about 278 hrs. Accordingly, the total stress of the blue pixel BPX calculated by the total stress calculator TSC may be about 508.9249.

In an embodiment, the size of the display panel 100 may be about 65 inches. The current efficiency cd/A of the red pixel RPX may be about 12.7 cd/A, the current efficiency cd/A of the green pixel GPX may be about 61.7 cd/A, and the current efficiency cd/A of the blue pixel BPX may be about 4.4 cd/A. The aperture ratio % of the red pixel RPX may be about 8.44%, the aperture ratio % of the green pixel GPX may be about 10.51%, and the aperture ratio % of the blue pixel BPX may be about 6.18%.

The current density ratio calculator CDRC may determine the current density mA/cm\hat{ }2 of the red pixel RPX (e.g. about 83.51 mA/cm\hat{ }2) based on the aperture ratio % of the red pixel RPX (e.g. about 8.44%). In addition, the current density ratio calculator CDRC may determine the current density mA/cm\hat{ }2 of the green pixel GPX (e.g. about 42.97 mA/cm\hat{ }2) based on the aperture ratio % of the green pixel GPX (e.g. about 10.51%). In addition, the current density ratio calculator CDRC may determine the current density mA/cm\hat{ }2 of the blue pixel BPX (e.g. about 117.08 mA/cm\hat{ }2) based on the aperture ratio % of the blue pixel BPX (e.g. about 6.18%).

The current density ratio calculator CDRC may calculate the current density ratio of the red pixel RPX, the current density ratio of the green pixel GPX, and the current density ratio of the blue pixel BPX, based on the current density mA/cm\hat{ }2 of the red pixel RPX, the current density mA/cm\hat{ }2 of the green pixel GPX, and the current density mA/cm\hat{ }2 of the blue pixel BPX.

The total stress calculator TSC may receive the lifetime data PLTD of the red pixel RPX, the lifetime data PLTD of the green pixel GPX, and the lifetime data PLTD of the blue pixel BPX from the external device. The lifetime PLT of the red pixel RPX may be about 277 hrs, the lifetime PLT of the green pixel GPX may be about 540 hrs, and the lifetime PLT of the blue pixel BPX may be about 307 hrs.

The total stress calculator TSC may calculate the total stress of the pixel PX using the equation ((CDR\hat{ }k)*PLT), where CDR is the current density ratio of the pixel PX, PLT is the lifetime PLT of the pixel PX, and k is the constant value. For example, k may be greater than or equal to about 1.3, and smaller than or equal to about 1.9. For example, k may be about 1.6. For example, k may be about 1.3. For example, k may be about 1.9. For convenience of illustration, k may be about 1.6 hereinafter.

The current density rato\hat{ }1.6 of the red pixel RPX may be about 0.843395, and the lifetime PLT of the red pixel RPX may be about 277 hrs. Accordingly, the total stress of the red pixel RPX calculated by the total stress calculator TSC may be about 233.6205. In addition, the current density rato\hat{ }1.6 of the green pixel GPX may be about 0.291282, and the lifetime PLT of the green pixel GPX may be about 540 hrs. Accordingly, the total stress of the green pixel GPX calculated by the total stress calculator TSC may be about 157.2925. In addition, the current density rato\hat{ }1.6 of the blue pixel BPX may be about 1.448179, and the lifetime PLT of the blue pixel BPX may be about 307 hrs. Accordingly, the total stress of the blue pixel BPX calculated by the total stress calculator TSC may be about 444.5907.

In an embodiment, the size of the display panel 100 may be about 77 inches. The current efficiency cd/A of the red pixel RPX may be about 13.3 cd/A, the current efficiency cd/A of the green pixel GPX may be about 65 cd/A, and the current efficiency cd/A of the blue pixel BPX may be about 4.4 cd/A. The aperture ratio % of the red pixel RPX may be about 8.05%, the aperture ratio % of the green pixel GPX may be about 10.1%, and the aperture ratio % of the blue pixel BPX may be about 5.94%.

The current density ratio calculator CDRC may determine the current density mA/cm\hat{ }2 of the red pixel RPX (e.g. about 82.7 mA/cm\hat{ }2) based on the aperture ratio % of the red pixel RPX (e.g. about 8.05%). In addition, the current density ratio calculator CDRC may determine the current density mA/cm\hat{ }2 of the green pixel GPX (e.g. about 42.44 mA/cm\hat{ }2) based on the aperture ratio % of the green pixel GPX (e.g. about 10.1%). In addition, the current density ratio calculator CDRC may determine the current density mA/cm\hat{ }2 of the blue pixel BPX (e.g. about 125.78 mA/cm\hat{ }2) based on the aperture ratio % of the blue pixel BPX (e.g. about 5.94%).

The current density ratio calculator CDRC may calculate the current density ratio of the red pixel RPX, the current density ratio of the green pixel GPX, and the current density ratio of the blue pixel BPX, based on the current density mA/cm\hat{ }2 of the red pixel RPX, the current density mA/cm\hat{ }2 of the green pixel GPX, and the current density mA/cm\hat{ }2 of the blue pixel BPX.

The total stress calculator TSC may receive the lifetime data PLTD of the red pixel RPX, the lifetime data PLTD of the green pixel GPX, and the lifetime data PLTD of the blue pixel BPX from the external device. The lifetime PLT of the red pixel RPX may be about 297 hrs, the lifetime PLT of the green pixel GPX may be about 587 hrs, and the lifetime PLT of the blue pixel BPX may be about 299 hrs.

The total stress calculator TSC may calculate the total stress of the pixel PX using the equation ((CDR\hat{ }k)*PLT), where CDR is the current density ratio of the pixel PX, PLT is the lifetime PLT of the pixel PX, and k is the constant value. For example, k may be greater than or equal to about 1.3, and smaller than or equal to about 1.9. For example, k may be about 1.6. For example, k may be about 1.3. For example, k may be about 1.9. For convenience of illustration, k may be about 1.6 hereinafter.

The current density rato\hat{ }1.6 of the red pixel RPX may be about 0.830345, and the lifetime PLT of the red pixel RPX may be about 297 hrs. Accordingly, the total stress of the red pixel RPX calculated by the total stress calculator TSC may be about 246.6124. In addition, the current density rato\hat{ }1.6 of the green pixel GPX may be about 0.285555, and the lifetime PLT of the green pixel GPX may be about 587 hrs. Accordingly, the total stress of the green pixel GPX calculated by the total stress calculator TSC may be about 167.621. In addition, the current density rato\hat{ }1.6 of the blue pixel BPX may be about 1.624158, and the lifetime PLT of the blue pixel BPX may be about 299 hrs. Accordingly, the total stress of the blue pixel BPX calculated by the total stress calculator TSC may be about 485.6232.

The threshold voltage variance calculator TVVC may calculate the threshold voltage variance ΔV of the first transistor T1 included in the pixel PX according to the total stress of the pixel PX. For example, the threshold voltage variance calculator TVVC may calculate the threshold voltage variance ΔV of the first transistor T1 included in the red pixel RPX according to the total stress of the red pixel RPX, and may calculate the threshold voltage variance ΔV of the first transistor T1 included in the green pixel GPX according to the total stress of the green pixel GPX. In addition, the threshold voltage variance calculator TVVC may calculate the threshold voltage variance ΔV of the first transistor T1 included in the blue pixel BPX according to the total stress of the blue pixel BPX.

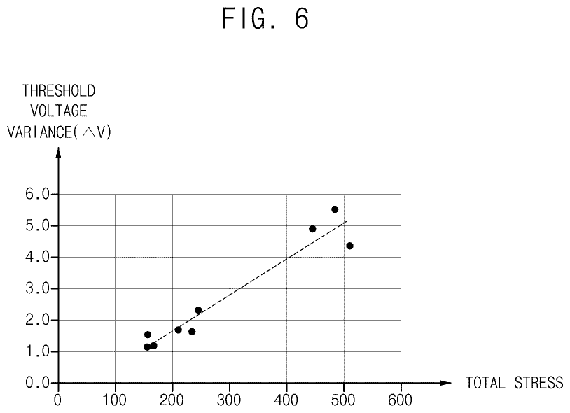

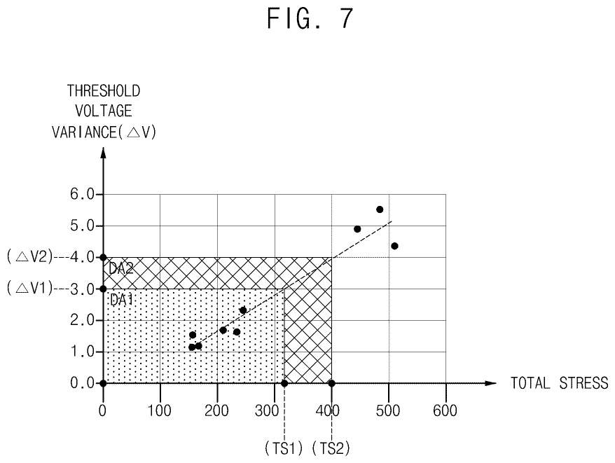

FIG. 6 is a graph illustrating a relationship between the total stress of the pixel PX and the threshold voltage variance ΔV. FIG. 7 is a graph illustrating a total stress range according to a driving voltage margin of the pixel PX.

Referring to FIGS. 6 and 7, the relationship between the threshold voltage variance ΔV of the first transistor T1 included in the pixel PX and the total stress of the pixel PX and may be a linear relationship. For example, the relationship between the threshold voltage variance ΔV of the first transistor T1 included in the red pixel RPX and the total stress of the red pixel RPX may be a linear relationship. For example, the relationship between the threshold voltage variance ΔV of the first transistor T1 included in the green pixel GPX and the total stress of the green pixel GPX may be a linear relationship. For example, the relationship between the threshold voltage variance ΔV of the first transistor T1 included in the blue pixel BPX and the total stress of the blue pixel BPX may be a linear relationship. For convenience of illustration, a graph representing the relationship between the total stress of the blue pixel BPX and the threshold voltage variance ΔV of the first transistor T1 included in the blue pixel BPX is illustrated in FIG. 6.

During the same time, the threshold voltage variance ΔV of the first transistor T1 included in the blue pixel BPX may be the greatest. In addition, during the same time, the total stress of the blue pixel BPX may be the greatest.

The aperture ratio determiner PARD may determine the relationship between the threshold voltage variance ΔV of the first transistor T1 included in the blue pixel BPX and the total stress of the blue pixel BPX. In other words, the aperture ratio determiner PARD may determine that the relationship between the threshold voltage variance ΔV of the first transistor T1 included in the blue pixel BPX and the total stress of the blue pixel BPX is a linear relationship based on the relationship between the threshold voltage variance ΔV of the first transistor T1 included in the blue pixel BPX and the total stress of the blue pixel BPX.

The aperture ratio determiner PARD may determine the aperture ratio of the blue pixel BPX based on the maximum threshold voltage compensation value and the relationship between the total stress of the blue pixel BPX and the threshold voltage variance ΔV of the first transistor T1 included in the blue pixel BPX. The maximum threshold voltage compensation value may refer to the maximum value of the compensation voltage for the threshold voltage variance ΔV of the first transistor T1 included in the blue pixel BPX. The aperture ratio determiner PARD may determine a first reference total stress of the blue pixel BPX corresponding to the maximum threshold voltage compensation value.

When the total stress of the blue pixel BPX calculated by the total stress calculator TSC is greater than the first reference total stress, the aperture ratio determiner PARD may determine the aperture ratio % based on the first reference total stress.

For example, the aperture ratio determiner PARD may determine the aperture ratio % so that a second reference total stress, which is smaller than the first reference total stress, is applied to the blue pixel BPX. The newly determined aperture ratio % may be higher than the initial aperture ratio %. When the aperture ratio % of the blue pixel BPX increases, the current efficiency cd/A of the blue pixel BPX may increase, and the current density mA/cm\hat{ }2 of the blue pixel BPX may decrease.

For example, the aperture ratio determiner PARD may determine the aperture ratio % so that the second reference total stress, which is equal to or substantially equal to the first reference total stress, is applied to the blue pixel BPX. The newly determined aperture ratio % may be higher than the initial aperture ratio %. When the aperture ratio % of the blue pixel BPX increases, the current efficiency cd/A of the blue pixel BPX may increase, and the current density mA/cm\hat{ }2 of the blue pixel BPX may decrease.

When the aperture ratio % of the blue pixel BPX increases, the current efficiency cd/A of the blue pixel BPX may increase, and the current density mA/cm\hat{ }2 of the blue pixel BPX may decrease. When the current efficiency cd/A of the blue pixel BPX increases, the total stress applied to the blue pixel BPX may decrease. When the total stress applied to the blue pixel BPX decreases, the threshold voltage variance ΔV of the first transistor T1 included in the blue pixel BPX may decrease. When the threshold voltage variance ΔV of the first transistor T1 included in the blue pixel BPX decreases, the threshold voltage variance ΔV of the first transistor T1 included in the blue pixel BPX may be smaller than the maximum threshold voltage compensation value. The threshold voltage variance ΔV of the first transistor T1 included in the blue pixel BPX may be within the compensation range for the threshold voltage of the first transistor T1 included in the blue pixel BPX, so that the blue pixel BPX may exactly emit light at the target luminance without the current reduction. In other words, the luminance expression capability of the blue pixel BPX may be improved. Accordingly, the display quality of the display device 1 may be improved.

In addition, when the current efficiency cd/A of the blue pixel BPX increases, the lifetime PLT of the blue pixel BPX may increase. The stability and the reliability of the display device 1 including the blue pixel BPX having the increased lifetime PLT may be improved.

In addition, when the current density mA/cm\hat{ }2 of the blue pixel BPX decreases, the driving current of the blue pixel BPX may decrease. Accordingly, the power consumption of the display device 1 including the blue pixel BPX having the decreased current density mA/cm\hat{ }2 may decrease.

In an embodiment, the aperture ratio determiner PARD may determine the first reference total stress TS1 (e.g. about 310) of the blue pixel BPX corresponding to the maximum threshold voltage compensation value ΔV1 (e.g. about 3.0V) of the first transistor T1 included in the blue pixel BPX.

When the total stress of the blue pixel BPX calculated by the total stress calculator TSC is greater than the first reference total stress TS1, the aperture ratio determiner PARD may determine the aperture ratio % based on the first reference total stress TS1. The total stress of the blue pixel BPX calculated based on the newly determined aperture ratio % may include a first area DA1. The newly determined aperture ratio % may be higher than the initial aperture ratio %. When the aperture ratio % of the blue pixel BPX increases, the current efficiency cd/A of the blue pixel BPX may increase, and the current density mA/cm\hat{ }2 of the blue pixel BPX may decrease.

When the aperture ratio % of the blue pixel BPX increases, the current efficiency cd/A of the blue pixel BPX may increase and the current density mA/cm\hat{ }2 of the blue pixel BPX may decrease. When the current efficiency cd/A of the blue pixel BPX increases, the total stress applied to the blue pixel BPX may decrease. When the total stress applied to the blue pixel BPX decreases, the threshold voltage variance ΔV of the first transistor T1 included in the blue pixel BPX may decrease. When the threshold voltage variance ΔV of the first transistor T1 included in the blue pixel BPX decreases, the threshold voltage variance ΔV of the first transistor T1 included in the blue pixel BPX may be smaller than the maximum threshold voltage compensation value. The threshold voltage variance ΔV of the first transistor T1 included in the blue pixel BPX may be within the compensation range for the threshold voltage of the first transistor T1 included in the blue pixel BPX, so that the blue pixel BPX may exactly emit light at the target luminance without the current reduction. In other words, the luminance expression capability of the blue pixel BPX may be improved. Accordingly, the display quality of the display device 1 may be improved.

In addition, when the current efficiency cd/A of the blue pixel BPX increases, the lifetime PLT of the blue pixel BPX may increase. The stability and the reliability of the display device 1 including the blue pixel BPX having the increased lifetime PLT may be improved.

In addition, when the current density mA/cm\hat{ }2 of the blue pixel BPX decreases, the driving current of the blue pixel BPX may decrease. Accordingly, the power consumption of the display device 1 including the blue pixel BPX having the decreased current density mA/cm\hat{ }2 may decrease.

In an embodiment, the aperture ratio determiner PARD may determine the first reference total stress TS2 (e.g. about 400) of the blue pixel BPX corresponding to the maximum threshold voltage compensation value ΔV2 (e.g. about 4.0V) of the first transistor T1 included in the blue pixel BPX.

When the total stress of the blue pixel BPX calculated by the total stress calculator TSC is greater than the first reference total stress TS2, the aperture ratio determiner PARD may determine the aperture ratio % based on the first reference total stress TS2. The total stress of the blue pixel BPX calculated based on the newly determined aperture ratio % may include a second area DA2. The newly determined aperture ratio % may be higher than the initial aperture ratio %. When the aperture ratio % of the blue pixel BPX increases, the current efficiency cd/A of the blue pixel BPX may increase, and the current density mA/cm\hat{ }2 of the blue pixel BPX may decrease.

When the aperture ratio % of the blue pixel BPX increases, the current efficiency cd/A of the blue pixel BPX may increase and the current density mA/cm\hat{ }2 of the blue pixel BPX may decrease. When the current efficiency cd/A of the blue pixel BPX increases, the total stress applied to the blue pixel BPX may decrease. When the total stress applied to the blue pixel BPX decreases, the threshold voltage variance ΔV of the first transistor T1 included in the blue pixel BPX may decrease. When the threshold voltage variance ΔV of the first transistor T1 included in the blue pixel BPX decreases, the threshold voltage variance ΔV of the first transistor T1 included in the blue pixel BPX may be smaller than the maximum threshold voltage compensation value. The threshold voltage variance ΔV of the first transistor T1 included in the blue pixel BPX may be within the compensation range for the threshold voltage of the first transistor T1 included in the blue pixel BPX, so that the blue pixel BPX may exactly emit light at the target luminance without the current reduction. In other words, the luminance expression capability of the blue pixel BPX may be improved. Accordingly, the display quality of the display device 1 may be improved.

In addition, when the current efficiency cd/A of the blue pixel BPX increases, the lifetime PLT of the blue pixel BPX may increase. The stability and the reliability of the display device 1 including the blue pixel BPX having the increased lifetime PLT may be improved.

In addition, when the current density mA/cm\hat{ }2 of the blue pixel BPX decreases, the driving current of the blue pixel BPX may decrease. Accordingly, the power consumption of the display device 1 including the blue pixel BPX having the decreased current density mA/cm\hat{ }2 may decrease.

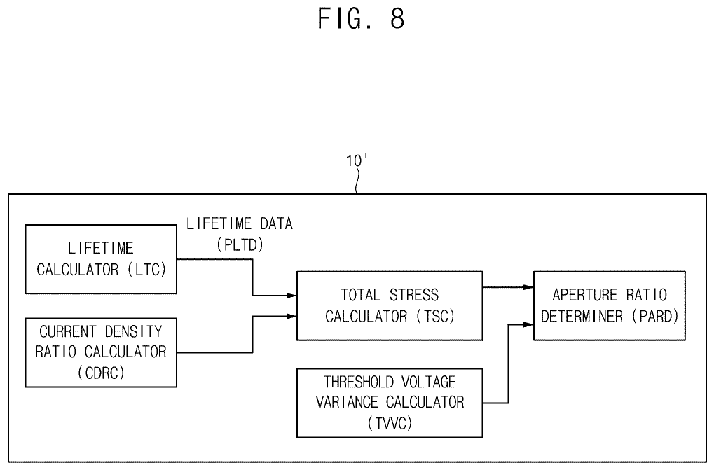

FIG. 8 is a block diagram illustrating an aperture ratio determination device 10′ according to an embodiment of the present disclosure.

Referring to FIG. 8, The aperture ratio determination device 10′ may include a lifetime calculator LTC, the current density ratio calculator CDRC, the total stress calculator TSC, the threshold voltage variance calculator TVVC, and the aperture ratio determiner PARD. The aperture ratio determination device 10′ may be the same or substantially the same as the aperture ratio determination device 10 described above with reference to FIG. 3, except that the aperture ratio determination device 10′ may further include the lifetime calculator LTC. Thus, the same reference symbols are used to refer to the same or substantially the same parts (or like parts) as those described above with reference to FIG. 3, and redundant description thereof may not be repeated.

The lifetime calculator LTC may calculate lifetime data PLTD corresponding to the lifetime PLT of the pixel PX. The lifetime PLT of the pixel PX may be the same as the sixth time T50. In other words, the lifetime calculator LTC may calculate a time used for the luminance maintenance ratio of the pixel PX to decrease from about 100% to about 50%. The lifetime calculator LTC may transmit the lifetime data PLTD for the lifetime PLT of the pixel PX to the total stress calculator TSC.

The newly determined aperture ratio % may be higher than the initial aperture ratio %. When the aperture ratio % of the pixel PX increases, the current efficiency cd/A of the pixel PX may increase, and the current density mA/cm\hat{ }2 of the pixel PX may decrease. When the current efficiency cd/A of the pixel PX increases, the total stress applied to the pixel PX may decrease. When the total stress applied to the pixel PX decreases, the threshold voltage variance ΔV of the first transistor T1 included in the pixel PX may decrease. When the threshold voltage variance ΔV of the first transistor T1 included in the pixel PX decreases, the threshold voltage variance ΔV of the first transistor T1 included in the pixel PX may be smaller than the maximum threshold voltage compensation value. The threshold voltage variance ΔV of the first transistor T1 included in the pixel PX may be within the compensation range for the threshold voltage of the first transistor T1 included in the pixel PX, so that the pixel PX may exactly emit light at the target luminance without the current reduction. In other words, the luminance expression capability of the pixel PX may be improved. Accordingly, the display quality of the display device 1 may be improved.

In addition, when the current efficiency cd/A of the pixel PX increases, the lifetime PLT of the pixel PX may increase. The stability and the reliability of the display device 1 including the pixel PX having the increased lifetime PLT may be improved.

In addition, when the current density mA/cm\hat{ }2 of the pixel PX decreases, the driving current of the pixel PX may decrease. Accordingly, the power consumption of the display device 1 including the pixel PX having the decreased current density mA/cm\hat{ }2 may decrease.

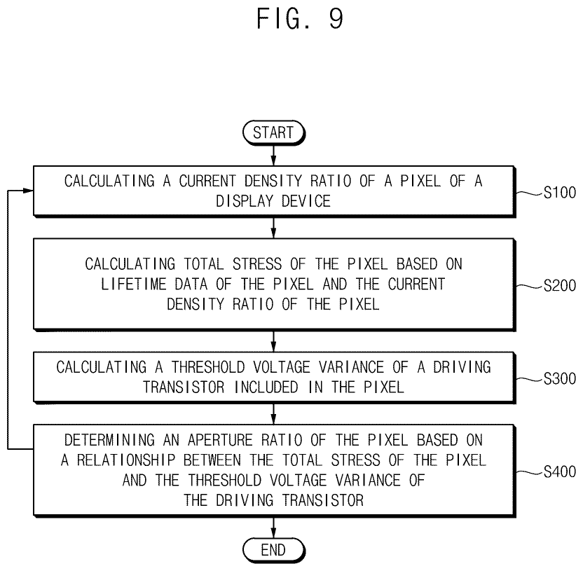

FIG. 9 is a flow chart illustrating a method of determining the aperture ratio.

Referring to FIG. 9, the method of determining the aperture ratio may include calculating the current density ratio of the pixel PX of the display device 1 (S100), calculating the total stress of the pixel PX based on the lifetime data of the pixel PX and the current density ratio of the pixel PX (S200), calculating the threshold voltage variance ΔV of the first transistor (e.g., the driving transistor) T1 included in the pixel PX (S300), and determining the aperture ratio of the pixel PX based on the relationship between the total stress of the pixel PX and the threshold voltage variance ΔV of the first transistor (e.g., the driving transistor) T1 (S400).

The method of determining the aperture ratio may be performed by the aperture ratio determination device 10. In other words, the aperture ratio determination device 10 may determine the aperture ratio % of the pixel PX by the method of determining the aperture ratio described above.

The calculating of the current density ratio of the pixel PX of the display device 1 (S100) may be performed by the current density ratio calculator CDRC of the aperture ratio determination device 10.

The calculating of the current density ratio of the pixel PX of the display device 1 (S100) may include calculating the current density mA/cm\hat{ }2 of the pixel PX based on the initial aperture ratio % of the pixel PX, and calculating the current density ratio of the pixel PX, which is the ratio of the current density mA/cm\hat{ }2 of the pixel PX to the reference current density mA/cm\hat{ }2 of the reference pixel.

The calculating of the total stress of the pixel PX based on the lifetime data PLTD of the pixel PX and the current density ratio of the pixel PX (S200) may be performed by the total stress calculator TSC of the aperture ratio determination device 10.

The calculating of the total stress of the pixel PX based on the lifetime data PLTD of the pixel PX and the current density ratio of the pixel PX (S200) may include calculating the total stress of the pixel PX using the equation ((CDR\hat{ }k)*PLT), where CDR is the current density ratio of the pixel, PLT is the lifetime PLT of the pixel PX corresponding to the lifetime data PLTD of the pixel PX, and k is the constant value. For example, k may be greater than or equal to about 1.3, and smaller than or equal to about 1.9. For example, k may be about 1.6. For example, k may be about 1.3. For example, k may be about 1.9.

The calculating of the threshold voltage variance ΔV of the first transistor T1 included in the pixel PX (S300) may be performed by the threshold voltage variance calculator TVVC of the aperture ratio determination device 10.

The determining of the aperture ratio % of the pixel PX based on the relationship between the threshold voltage variance ΔV of the first transistor T1 and the total stress of the pixel PX (S400) may be performed by the aperture ratio determiner PARD of the aperture ratio determination device 10.

When the total stress of the pixel PX having the newly determined aperture ratio % is greater than the first reference total stress corresponding to the maximum threshold voltage compensation value, the aperture ratio determination device 10 may perform the method of determining the aperture ratio again from the calculating of the current density ratio of the pixel PX of the display device 1 (S100).

The method of determining the aperture ratio performed by the aperture ratio determination device 10 may be the same or substantially the same as an operation of the aperture ratio determination device 10 described above with reference to FIGS. 1 to 7. Thus, redundant description of the method of determining the aperture ratio will not be repeated.

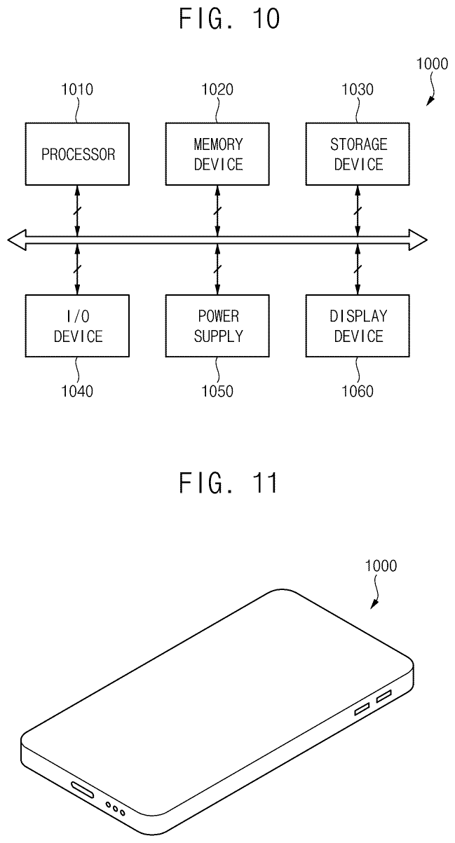

FIG. 10 is a block diagram illustrating an electronic device 1000 according to some embodiments of present disclosure. FIG. 11 is a diagram illustrating the electronic device 1000 of FIG. 10 implemented as a smart phone according to an embodiment of the present disclosure.

Referring to FIGS. 10 and 11, the electronic device 1000 may include a processor 1010, a memory device 1020, a storage device 1030, an input/output (I/O) device 1040, a power supply 1050, and a display device 1060. The display device 1060 may be the display device 1 described above with reference to FIG. 1. In addition, the electronic device 1000 may further include ports for communicating with a video card, a sound card, a memory card, a universal serial bus (USB) device, another electronic device, and the like.

In an embodiment, as illustrated in FIG. 11, the electronic device 1000 may be implemented as the smart phone. However, the present disclosure is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and/or the like.

The processor 1010 may perform various suitable computing functions. The processor 1010 may be a micro processor, a central processing unit (CPU), an application processor (AP), and/or the like. The processor 1010 may be coupled to the other components via an address bus, a control bus, a data bus, and the like. Further, the processor 1010 may be coupled to an extended bus, such as a peripheral component interconnection (PCI) bus.

The processor 1010 may output the input image data IMG and the input control signal CONT to the driving controller 200 included in the display device 1.

The memory device 1020 may store data for operations of the electronic device 1000. For example, the memory device 1020 may include at least one non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like, and/or at least one volatile memory device, such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, and/or the like.

The I/O device 1040 may include an input device, such as a keyboard, a keypad, a mouse device, a touch-pad, a touch-screen, and/or the like, and an output device, such as a printer, a speaker, and/or the like. According to an embodiment, the I/O device 1040 may include the display device 1060.

The power supply 1050 may provide power for operations of the electronic device 1000.

The display device 1060 may be connected to other components through buses or other communication links.

The display device 1060 may include the pixel PX having the aperture ratio % determined by the aperture ratio determination device 10 described above with reference to FIGS. 1 to 7.

The aperture ratio determination device 10 may determine the aperture ratio % of the pixel PX by the method of determining the aperture ratio described above with reference to FIGS. 1 to 9.

The aperture ratio % determined by the method of determining the aperture ratio may be higher than the initial aperture ratio %. The newly determined aperture ratio % may be higher than the initial aperture ratio %. When the aperture ratio % of the pixel PX increases, the current efficiency cd/A of the pixel PX may increase, and the current density mA/cm\hat{ }2 of the pixel PX may decrease. When the current efficiency cd/A of the pixel PX increases, the total stress applied to the pixel PX may decrease. When the total stress applied to the pixel PX decreases, the threshold voltage variance ΔV of the first transistor T1 included in the pixel PX may decrease. When the threshold voltage variance ΔV of the first transistor T1 included in the pixel PX decreases, the threshold voltage variance ΔV of the first transistor T1 included in the pixel PX may be smaller than the maximum threshold voltage compensation value. The threshold voltage variance ΔV of the first transistor T1 included in the pixel PX may be within the compensation range for the threshold voltage of the first transistor T1 included in the pixel PX, so that the pixel PX may exactly emit light at the target luminance without the current reduction. In other words, the luminance expression capability of the pixel PX may be improved. Accordingly, the display quality of the display device 1 may be improved.

In addition, when the current efficiency cd/A of the pixel PX increases, the lifetime PLT of the pixel PX may increase. The stability and the reliability of the display device 1 including the pixel PX having the increased lifetime PLT may be improved.

In addition, when the current density mA/cm\hat{ }2 of the pixel PX decreases, the driving current of the pixel PX may decrease. Accordingly, the power consumption of the display device 1 including the pixel PX having the decreased current density mA/cm\hat{ }2 may decrease.

Some embodiments of the present disclosure may be applied to a display device, and an electronic device including the display device. For example, some embodiments of the present disclosure may be applied to a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, and/or the like.

The electronic or electric devices and/or any other relevant devices or components according to embodiments of the present disclosure described herein (e.g., the current density ratio calculator, the total stress calculator, the threshold voltage variance calculator, the aperture ratio determiner, the lifetime calculator, and the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A method of determining an aperture ratio, the method comprising:
calculating a current density ratio of a pixel of a display device;
calculating a total stress of the pixel based on lifetime data of the pixel and the current density ratio of the pixel;
calculating a threshold voltage variance of a driving transistor included in the pixel; and
determining the aperture ratio of the pixel based on a relationship between the total stress of the pixel and the threshold voltage variance of the driving transistor.

2. The method of claim 1, wherein the lifetime data of the pixel corresponds to a lifetime used for a luminance maintenance ratio of the pixel to decrease from about 100% to about 50%.

3. The method of claim 1, wherein the calculating of the current density ratio of the pixel comprises:
calculating a current density of the pixel based on an initial aperture ratio of the pixel; and
calculating the current density ratio of the pixel by calculating a ratio of the current density of the pixel to a reference current density of a reference pixel.

4. The method of claim 1, wherein the total stress of the pixel is calculated based on (CDR\hat{ }k)*PLT, where CDR is the current density ratio of the pixel, PLT is a lifetime of the pixel corresponding to the lifetime data of the pixel, and k is a constant value.

5. The method of claim 1, wherein the relationship between the total stress of the pixel and the threshold voltage variance of the driving transistor is a linear relationship.

6. The method of claim 5, wherein the determining of the aperture ratio of the pixel comprises:
determining a first reference total stress corresponding to a maximum threshold voltage compensation value corresponding to a maximum value of a compensation voltage for the threshold voltage variance of the driving transistor.

7. The method of claim 6, wherein the determining of the aperture ratio of the pixel further comprises:
determining the aperture ratio corresponding to the first reference total stress when the total stress is greater than the first reference total stress.

8. The method of claim 6, wherein the determining of the aperture ratio of the pixel further comprises:
determining the aperture ratio corresponding a second reference total stress that is less than the first reference total stress when the total stress is greater than the first reference total stress.

9. An aperture ratio determination device comprising:
a current density ratio calculator configured to calculate a current density ratio of a pixel;
a total stress calculator configured to calculate a total stress of the pixel based on lifetime data of the pixel and the current density ratio of the pixel;
a threshold voltage variance calculator configured to calculate a threshold voltage variance of a driving transistor included in the pixel; and
an aperture ratio determiner configured to determine an aperture ratio of the pixel based on the threshold voltage variance of the driving transistor and the total stress of the pixel.

10. The aperture ratio determination device of claim 9, wherein the lifetime data of the pixel corresponds to a lifetime used for a luminance maintenance ratio of the pixel to decrease from about 100% to about 50%.

11. The aperture ratio determination device of claim 9, wherein the current density ratio calculator is configured to calculate a current density of the pixel based on an initial aperture ratio of the pixel, and calculate the current density ratio of the pixel by calculating a ratio of the current density of the pixel to a reference current density of a reference pixel.

12. The aperture ratio determination device of claim 9, further comprising:
a lifetime calculator configured to calculate a lifetime used for a luminance maintenance ratio of the pixel to decrease from about 100% to about 50%, and provide the lifetime data corresponding to the lifetime of the pixel to the total stress calculator.

13. The aperture ratio determination device of claim 9, wherein the total stress calculator is configured to calculate the total stress of the pixel based on (CDR\hat{ }K)*PLT, where CDR is the current density ratio of the pixel, PLT is a lifetime of the pixel corresponding to the lifetime data of the pixel, and k is a constant value.

14. The aperture ratio determination device of claim 9, wherein the aperture ratio determiner is configured to determine a relationship between the total stress of the pixel and the threshold voltage variance of the driving transistor.

15. The aperture ratio determination device of claim 14, wherein the relationship between the total stress of the pixel and the threshold voltage variance of the driving transistor is a linear relationship.

16. The aperture ratio determination device of claim 15, wherein the aperture ratio determiner is configured to determine a first reference total stress corresponding to a maximum threshold voltage compensation value corresponding to a maximum value of a compensation voltage for the threshold voltage variance of the driving transistor.

17. The aperture ratio determination device of claim 16, wherein the aperture ratio determiner is configured to determine the aperture ratio corresponding to the first reference total stress when the total stress is greater than the first reference total stress.

18. The aperture ratio determination device of claim 16, wherein the aperture ratio determiner is configured to determine a second reference total stress that is less than the first reference total stress when the total stress is greater than the first reference total stress, and determine the aperture ratio corresponding to the second reference total stress.

19. An electronic device comprising:
a processor configured to output an input control signal and input image data;
a display panel comprising a pixel;
a scan driver configured to output a scan signal to the pixel;
a data driver configured to output a data voltage to the pixel;
a sensing circuit connected to the pixel through a sensing line; and
a driving controller configured to control the scan driver, the data driver, and the sensing circuit, based on the input control signal and the input image data,
wherein a current density ratio of the pixel is calculated,
wherein a total stress of the pixel is calculated based on lifetime data of the pixel and the current density ratio of the pixel,
wherein a threshold voltage variance of a driving transistor included in the pixel is calculated, and
wherein an aperture ratio of the pixel is determined based on a relationship between the total stress of the pixel and the threshold voltage variance of the driving transistor.

20. The electronic device of claim 19, wherein the current density ratio is a ratio of a current density of the pixel to a reference current density of a reference pixel,
wherein the lifetime data corresponds to a lifetime of the pixel, and
wherein the total stress is calculated based on (CDR\hat{ }k)*PLT, where CDR is the current density ratio of the pixel, PLT is the lifetime of the pixel corresponding to the lifetime data of the pixel, and k is a constant value.
